(19) United States
(12) Patent Application Publication
(10) Pub. No.: US 2015/0100414 A1
(43) Pub. Date: Apr. 9, 2015

(54) METHOD AND APPARATUS FOR DETERMINING BRAND AWARENESS BEFORE DISMISSING A VIDEO ADVERTISEMENT

(71) Applicant: Adobe Systems Incorporated, San Jose, CA (US)

(72) Inventor: Niraj Gupta, Faridabad (IN)

(73) Assignee: Adobe Systems Incorporated, San Jose, CA (US)

(21) Appl. No.: 14/048,589

(22) Filed: Oct. 8, 2013

(51) Int. Cl. G06Q 30/02

(52) U.S. Cl. CPC G06Q 30/0245
USPC 705/14.44

(57) ABSTRACT

A computer implemented method and apparatus for determining brand awareness before dismissing a video advertisement. The method comprises receiving video content, advertising content, and a test question, wherein the test question tests brand awareness of a viewer of the advertising content; playing the advertising content; presenting the test question; stopping the advertising content when an input is received that correctly answers the test question; and playing the video content.

### BACKGROUND OF THE INVENTION

1. Field of the Invention

Embodiments of the present invention generally relate to video advertising and, more particularly, to a method and apparatus for determining brand awareness before dismissing a video advertisement.

2. Description of the Related Art

Video advertising is often used for brand building. When a video is viewed online, video advertising often precedes the actual video content. An overlay is often used to provide a viewer with a “SKIP” button that allows the viewer to dismiss the advertisement after a predefined number of seconds. Today, advertisements can provide a short story where the actual product is not revealed until well into the advertisement, yet the viewer is able to dismiss the advertisement without ever knowing what brand is advertised. Marketers spend a great deal of money to raise brand awareness and dismissing ads results in lost marketing opportunity and revenue.

Therefore, there is a need for a method and apparatus for determining brand awareness before dismissing a video advertisement.

### SUMMARY OF THE INVENTION

A method and apparatus for determining brand awareness before dismissing a video advertisement is provided. The method receives video content, advertising content, and a test question, wherein the test question tests brand awareness of a viewer of the advertising content. When the advertising content is played, a test question is presented with it. The test question tests brand awareness of the advertising content. When a correct response to the test question is received, the advertising content is stopped and the video content is played.

The Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a system for determining brand awareness before dismissing a video advertisement, according to one or more embodiments;

FIG. 2 depicts a flow diagram of a method for determining brand awareness before dismissing a video advertisement as performed by the content display module of FIG. 1, according to one or more embodiments; and

FIG. 3 depicts a flow diagram of a method for determining brand awareness before dismissing a video advertisement as performed by the content display module of FIG. 1, according to one or more embodiments.

While the method and apparatus is described herein by way of example for several embodiments and illustrative drawings, those skilled in the art will recognize that the method and apparatus for determining brand awareness before dismissing a video advertisement is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for determining brand awareness before dismissing a video advertisement defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to. Additionally, the word “branding” includes not only the brand name for a product, but also includes other particulars of the marketing and advertising messages attempted to be conveyed concerning a product, such as advantages obtained by use of the product, the manufacturer or supplier of the product, etc.

### DETAILED DESCRIPTION OF EMBODIMENTS

Embodiments of the present invention include a method and apparatus for determining brand awareness before dismissing a video advertisement. When advertising content is created, the advertiser or marketer also develops test questions that can be used to test awareness of a key message in the advertising content or recall of the brand in the advertising content. The embodiments receive video content, advertising content, and one or more test questions for presentation to a user of a video terminal. While the advertising content is being displayed, the test question regarding the branding of the product is also presented. If a user answers the test question correctly, the advertising content is stopped and the video content is displayed. However, if the user does not answer correctly or fails to answer the test question at all, the advertising content is displayed in its entirety. When the test question is answered correctly, it implies that the user is aware of the brand and/or understands the message of the advertising content.

Advantageously, the present invention may be used as a plug-in to a video content player. Marketers who use advertising solutions, such as ADOBE° AUDITUDE° or ADOBE° Primetime can know the engagement of viewers of their advertisements and ensure greater awareness of their brands. Rather than skip an ad before the product or message is displayed in the advertisement, a user must view the advertisement until enough information is provided to answer a test question that shows they are aware of the brand, or view the advertisement in its entirety.

Various embodiments of a method and apparatus for determining brand awareness before dismissing a video advertisement are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

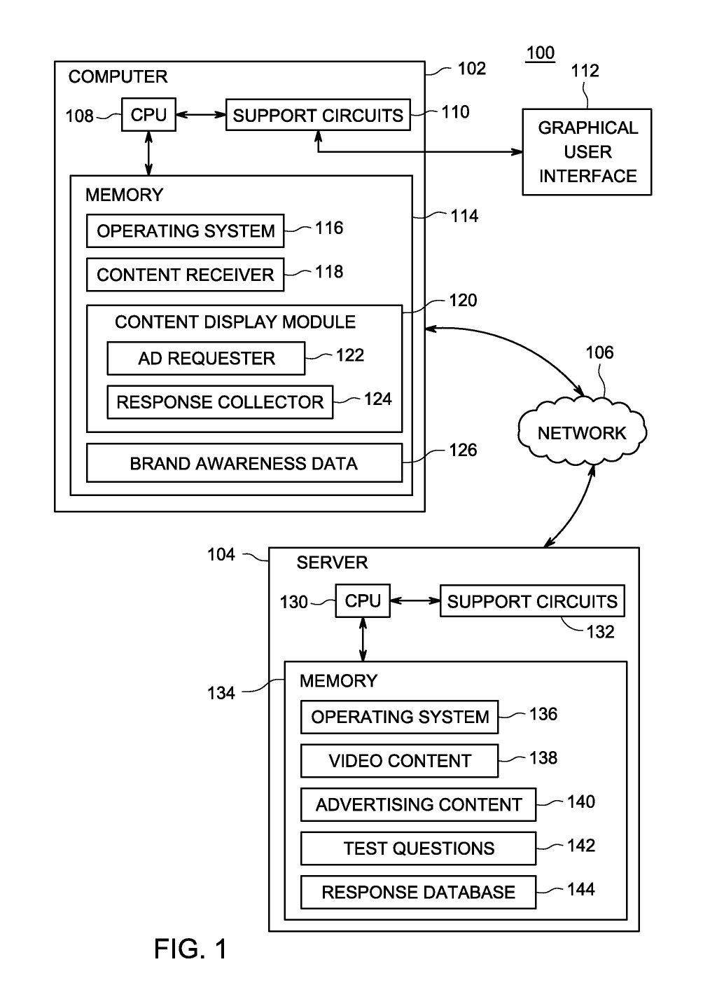

FIG. 1 is a block diagram of a system 100 for determining brand awareness before dismissing a video advertisement, according to one or more embodiments. The system 100 includes a computer 102 and a server 104, communicatively coupled to one another via a network 106. The computer 102 is a computing device that executes desktop media playing software, such as ADOBE® FLASH® Player, a gaming system that streams digital media, such as an XBOX®, and the like. The computer 102 includes a Central Processing Unit (CPU) 108, support circuits 110, and a memory 114 that includes or is attached to a graphical user interface 112. The CPU 108 may include one or more commercially available microprocessors or microcontrollers that facilitate data processing and storage. The various support circuits 110 facilitate the operation of the CPU 108 and include one or more clock circuits, power supplies, cache, input/output circuits, and the like. The memory 114 includes at least one of Read Only Memory (ROM), Random Access Memory (RAM), disk drive storage, optical storage, removable storage and/or the like.

The memory 114 includes an operating system 116, a content receiver 118, a content display module 120, and brand awareness data 126. The content display module 120 includes an ad requestor 122 and a response collector 124. The operating system 116 may include various commercially known operating systems. The content receiver 118 may be a video player on a computer, such as ADOBE® FLASH® player or a video portal on a gaming system, and the like, capable of receiving and playing the video content.

The network 106 includes a communication system that connects computers (or devices) by wire, cable, fiber optic and/or wireless link facilitated by various types of well-known network elements, such as hubs, switches, routers, and the like. The network 106 may be a part of the Intranet using various communications infrastructure, such as Ethernet, Wi-Fi, a personal area network (PAN), a wireless PAN, Bluetooth, Near field communication, and the like.

The server 104 is a computing device, for example a desktop computer, laptop, tablet computer, and the like. The server 104 is a marketing server such as ADOBE® AUDITUDE® that provides video advertising with video content. The server 104 includes a Central Processing Unit (CPU) 130, support circuits 132, and a memory 134. The CPU 130 may include one or more commercially available microprocessors or microcontrollers that facilitate data processing and storage. The various support circuits 132 facilitate the operation of the CPU 130 and include one or more clock circuits, power supplies, cache, input/output circuits, and the like. The memory 134 includes at least one of Read Only Memory (ROM), Random Access Memory (RAM), disk drive storage, optical storage, removable storage and/or the like. Although server 104 is shown as a single device, storage of one or more of the video content 138, advertising content 140, test question 142, and response database 144 can be distributed among multiple servers.

The memory 134 includes an operating system 136, video content 138, advertising content 140, test question 142, and a response database 144. The operating system system 136 may include various commercially known operating systems.

When video content 138 is requested from the server 104 on the computer 102, the server 104 sends the video content 138, advertising content 140, and a test question 142 to the content receiver 118. The video content 138 includes ad breaks that define a location where advertising content 138 is to be displayed. The test question 142 may include “What product is being advertised?”, “What company is advertising the product?”, “What is the message of the advertisement?”, and the like, to test the brand awareness or attention to the advertisement of the user. Although the test question is typically related in some way to the advertising content, such relation is not required, for example, if it is just user attention that is being tested. In some embodiments, test questions 142 are multiple choice questions that provide a user with answer choices. In some embodiments, interactive mechanisms other than question and answer may be utilized for testing brand awareness or attention to the advertisement. The content display module 120 displays the video content 138 until there is an ad break in the video content 138. The ad break defines a point during the playing of the video content 138 where advertising content 140 is to be displayed. The ad break may be before the video content 138 begins, at multiple points within the video content 138 and/or at the end of the video content 138. When the video content 138 arrives at an ad break, the ad requestor 122 sends the brand awareness data 126 to the server 104, which uses the brand awareness data 126 to select appropriate advertising content 140, or other uses as may be desired in the future. The ad requestor 122 receives the advertising content 140 on the computer 102. The content display module 120 displays the advertising content 140 and test question 142.

In one embodiment, display of the video content 138 is stopped and the advertising content 140 is displayed. In another embodiment, the content display module 120 displays the advertising content 140 outside of the video window where the video content 138 is displayed. In yet another embodiment, the content display module 120 displays the advertising content within the video window where the video content 138 is displayed, but in a way that does not overlap with the video content 138. The test question 142 is displayed in an overlay over the advertising content 140. The overlay may be interacted with by a viewer in order for the viewer to input a response to the test question 142. A correct response to a test question is interpreted as awareness of the brand in the advertising content 140.

The content display module 120 plays the advertising content 140, displays the test question 142, and waits for a viewer of the advertising content 140 to provide input via the graphical user interface 112 in response to the test question 142. If an input is received, the response collector 124 determines whether the response to the test question 142 is correct. If the response is correct, information regarding the advertising content 140 is stored as brand awareness data 126 to signify brand awareness of the brand advertised in the advertising content 140. The response is also sent to the server 104 and stored in a response database 144, which marketers may use to analyze brand awareness or for other purposes in the future. In some embodiments, when a correct answer is received, the content display module 120 stops playing the advertising content 140 and resumes play of the video content 138. In other embodiments, when a correct answer is received, the ad requestor 122 requests a different advertising content 140 to display with a different test question 142. If no input is received in response to the test question 142 or an incorrect answer is received, the content display module 120 displays the advertising content 140 in its entirety. The content display module 120 then resumes play of the video content 138. In some embodiments, multiple test questions 142, such as three, can be presented to a user, and a correct response to two of the three questions may be required before the user reply is considered to be a correct response. It is noted that “presentation” of the test questions(s) to the user is not limited to display via, for example, a video portion (not shown) of the graphical user interface 112, and in an alternative embodiment, an audio portion of the graphical user interface 112 can provide presentation of the test question(s). Additionally, an audio input device, such as a microphone (not shown) could be used to receive the users input at the graphical user interface 112 or to supply the user input directly to the computer 102.

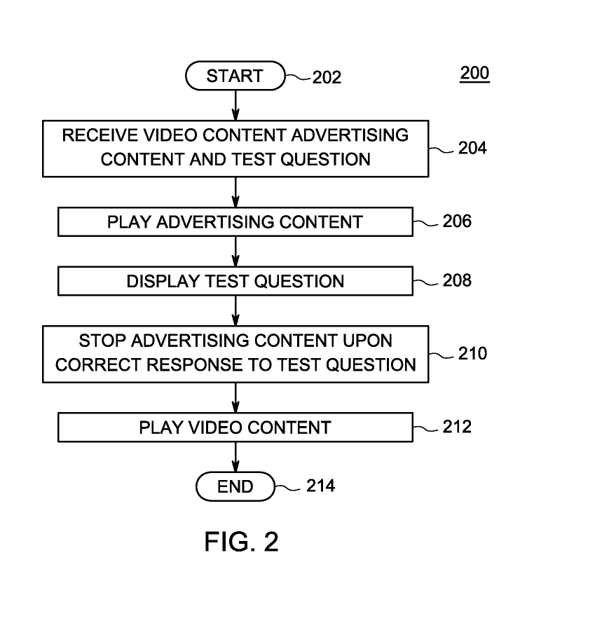

FIG. 2 is a flowchart of a method 200 for determining brand awareness before dismissing a video advertisement as performed by the content display module 120 of FIG. 1, according to one or more embodiments. The method 200 displays advertising content with a test question. If a viewer answers the test question correctly, playing of the advertising content is stopped and the video content is played. The method 200 starts at step 202 and proceeds to step 204.

At step 204, the method 200 receives video content, advertising content, and a test question. The test question tests a user awareness of the content in the advertising content. For example, the test question may test the brand advertised in the advertising content with questions such as, “What product is being advertised?”, “What company is advertising the product?”, “What is the message of the advertisement?”, and the like.

The method 200 proceeds to step 206, where the method 200 plays the advertising content. In some embodiments, the method 200 plays the advertising content in a display window where the video content is displayed. In some embodiments, the method 200 displays the advertising content in an outside video window. In some embodiments, the method 200 displays the advertising content in the same display window as the video content, but in a location that does not overlap with the video content.

The method 200 proceeds to step 208, where the method 200 displays the test question. The method 200 displays the test question in an overlay over the window where the advertising content is displayed. The overlay is interactive and a viewer of the advertising content and test question may interact with the overlay in order to select or input a response to the test question.

The method 200 proceeds to step 210, where the method 200, upon receipt of a correct response to the test question, stops playing the advertising content. A viewer may choose not to respond to a test question, respond to a test question incorrectly, or respond to a test question correctly. If the method 200 determines that a correct response to the test question is received, the method 200 proceeds to step 212. If the user does not respond to the test question or responds incorrectly, the method 200 displays the advertising content in its entirety and then proceeds to step 212.

At step 212, where the method 200 plays the video content. The method 200 proceeds to step 214 and ends.

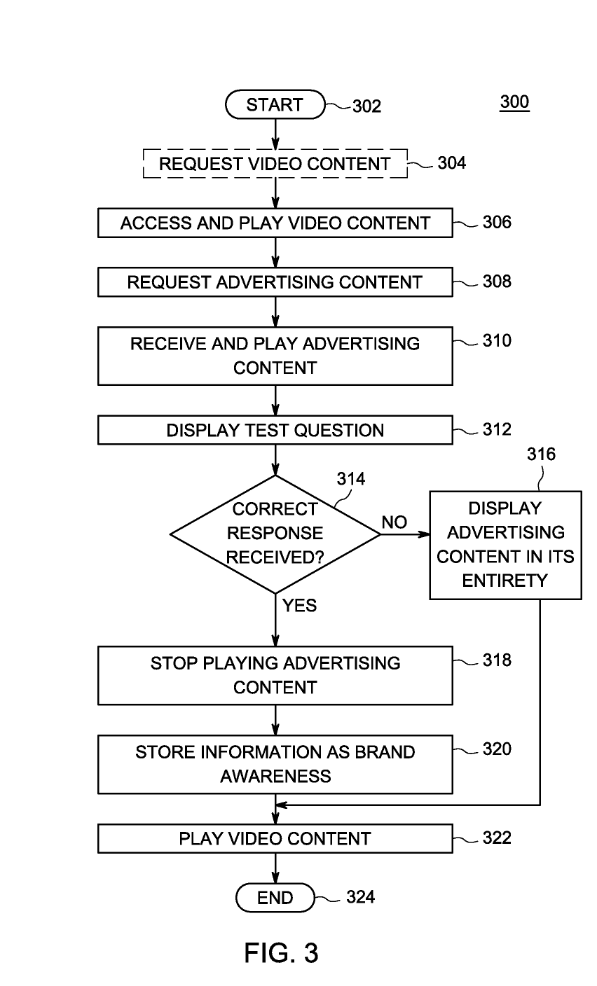

FIG. 3 is a flowchart of a method 300 for determining brand awareness before dismissing a video advertisement as performed by the content display module 120 of FIG. 1, according to one or more embodiments. The method 300 displays advertising content with a test question. If a viewer answers the test question correctly, playing of the advertising content is stopped and the video content is played. The method 300 starts at step 302 and proceeds to step 304.

At step 304, the method 300 optionally requests video content. The request may be for an on-line video to be viewed on a computer, or a video to be viewed on a television, gaming system, or other video terminal that is connected to the Internet in order to receive video content. The request may be sent to a marketing server that provides video content along with advertising content or that provides advertising content to an additional server that packages the advertising content with the requested video content for fulfilling the request. When the video content is on a medium, such as a DVD or the video content is a pre-installed application on a mobile device, a request for content is not required. Thus, the method 300 may be used in any environment where a video advertisement is capable of being interacted with.

The method 300 proceeds to step 306, where the method 300 accesses and displays the video content. In some embodiments, the video content includes markers for advertisements, hereafter referred to as ad breaks. An ad break may be at the beginning of the video content, before the video content starts. The ad breaks may be at one or more locations in the middle of the video content and may also be at the end of the video content. When the method 300 arrives at an ad breaks, the method 300 proceeds to step 308. In other embodiments, for example, if an advertisement is pre-embedded on a DVD or is already on a hard drive of a computing device, advertising content need not be requested, and the method 300 proceeds directly to step 310.

At step 308, the method 300 requests advertising content. The method 300 facilitates sending the request to an advertising content provider. The method 300 sends a file that includes brand awareness information to the advertising content provider. The file includes information that identifies advertisements, using, for example, an advertisement identifier, for all advertisements for which the viewer has shown brand awareness. The brand awareness information file may be used by the advertising content provider to provide advertising content for which the viewer has not previously shown brand awareness.

The method 300 proceeds to step 310, where the method 300 receives and displays the advertising content. In embodiments where the advertising content is pre-embedded, the method 300 accesses and displays the advertising content. In embodiments where advertising content is requested, the method 300 also receives one or more test questions associated with the advertising content. In some embodiments, the method 300 receives a single video advertisement and a single test question. In other embodiments, the method 300 receives a plurality of video advertisements along with one or more test questions associated with each video advertisement. The method 300 displays the advertising content. In some embodiments, the method 300 stops playing the video content and plays the advertising content in a display window where the video content was displayed. In some embodiments, the method 300 displays the advertising content in an outside video window. In some embodiments, the method 300 displays the advertising content in the same display window as the video content, but in a location that does not overlap with the video content.

The method 300 proceeds to step 312, where the method 300 displays the test question. The method 300 displays the test question in an overlay over the window where the advertising content is displayed. The overlay is interactive and a viewer of the advertising content and test question may interact with the overlay in order to select or input a response to the test question.

The method 300 proceeds to step 314, where the method 300 determines whether the viewer is found to be brand aware. The method 300 determines that a viewer is brand aware if the user inputs a correct response to the test question. A viewer may choose not to respond to a test question, respond to a test question incorrectly, or respond to a test question correctly. If the method 300 determines that a correct response to the test question is received, the method 300 proceeds to step 318.

At step 318, the method 300 stops playing the advertising content and the method 300 proceeds to step 320. At step 320, the method 300 stores information indicating brand awareness. In some embodiments, the method 300 stores an advertising identifier in the brand awareness file, where the advertising identifier identifies a specific advertisement. In some embodiments, the method 300 stores a brand identifier that is associated with the specific advertisement for which the viewer has shown brand awareness. This information may be used by the advertising content provider to select appropriate advertising content for the viewer. The method 300 proceeds to step 322.

However, if at step 314, the method 300 determines that a correct answer was not received, the method 300 proceeds to step 316, where the method 300 displays the advertising content in its entirety. The method 300 proceeds to step 322.

At step 322, the method 300 displays the video content, proceeds to step 324, and ends.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method comprising:
receiving video content, advertising content, and a test question, wherein the test question tests brand awareness of a viewer of the advertising content;
playing the advertising content;
presenting the test question;
stopping the advertising content when an input is received that correctly answers the test question; and
playing the video content.

2. The method of claim 1, wherein brand awareness comprises being aware of at least one of a product name in the advertising content, a company name in the advertising content, or a message of the advertising content.

3. The method of claim 1, wherein presenting the test question comprises providing a video overlay comprising display of the test question on the advertising content.

4. The method of claim 1, wherein receiving an incorrect answer to the test question or no answer to the test question causes the advertising content to be displayed in its entirety.

5. The method of claim 1, wherein a correct answer to the test question is interpreted as brand awareness and is stored as brand awareness data on the computer that plays the video content.

6. The method of claim 1, wherein the received advertising content comprises advertising content for a brand for which brand awareness has not been shown.

7. The method of claim 1, wherein when an input is received that correctly answers a test question, and a second advertising content is played comprising a second test question.

8. An apparatus for determining brand awareness before dismissing a video advertisement comprising:
a computer having one or more processors and further comprising:
a content receiver for receiving video content, advertising content, and a test question, wherein the test question tests brand awareness of a viewer of the advertising content; and
a content display module for playing the advertising content, presenting the test question, stopping the advertising content when an input is received that correctly answers the test question, and playing the video content.

9. The apparatus of claim 8 wherein brand awareness comprises being aware of at least one of a product name in the advertising content, a company name in the advertising content, or a message of the advertising content.

10. The apparatus of claim 8, wherein presenting the test question comprises providing a video overlay comprising display of the test question on the advertising content.

11. The apparatus of claim 8, wherein a correct answer to the test question is interpreted as brand awareness and is stored as brand awareness data on the computer that plays the video content.

12. The apparatus of claim 8, wherein the received advertising content comprises advertising content for a brand for which brand awareness has not been shown.

13. The apparatus of claim 8, wherein when an input is received that correctly answers a test question, and a second advertising content is played comprising a second test question.

14. A non-transient computer readable medium for storing computer instructions that, when executed by at least one processor causes the at least one processor to perform a method for determining brand awareness before dismissing a video advertisement comprising:
receiving video content, advertising content, and a test question, wherein the test question tests brand awareness of a viewer of the advertising content;
playing the advertising content;
presenting the test question;
stopping the advertising content when an input is received that correctly answers the test question; and
playing the video content.

15. The computer readable medium of claim 14, wherein brand awareness comprises being aware of at least one of a product name in the advertising content, a company name in the advertising content, or a message of the advertising content.

16. The computer readable medium of claim 14, wherein presenting the test question comprises providing a video overlay comprising display of the test question on the advertising content.

17. The computer readable medium of claim 14, wherein receiving an incorrect answer to the test question or no answer to the test question causes the advertising content to be displayed in its entirety.

18. The computer readable medium of claim 14, wherein a correct answer to the test question is interpreted as brand awareness and is stored as brand awareness data on the computer that plays the video content.

19. The computer readable medium of claim 14, wherein the received advertising content comprises advertising content for a brand for which brand awareness has not been shown.

20. The computer readable medium of claim 14, wherein when an input is received that correctly answers a test question, and a second advertising content is played comprising a second test question.
